(19) United States
(12) Patent Application Publication
(10) Pub. No.: US 2019/0344843 A1
(43) Pub. Date: Nov. 14, 2019

(54) RUBBER CRAWLER

(71) Applicant: BRIDGESTONE CORPORATION, Chuo-ku Tokyo (JP)

(72) Inventors: Takashi MIZUSAWA, Yokohama-shi, Kanagawa (JP); Shoko NAGAMOTO, Chuo-ku, Tokyo (JP)

(73) Assignee: BRIDGESTONE CORPORATION, Chuo-ku Tokyo (JP)

(21) Appl. No.: 16/475,773

(22) PCT Filed: Jan. 19, 2018
(86) PCT No.: PCT/JP2018/001662

§ 371 Date: Jul. 3, 2019

(30) Foreign Application Priority Data
Jan. 20, 2017 (JP) 2017-008926

(51) Int. Cl. B62D 55/24; B62D 55/26

(52) U.S. Cl. CPC B62D 55/244; B62D 55/26

(57) ABSTRACT

A rubber crawler (10) includes an endless rubber elastic body and protruding lugs (11) formed on the outer peripheral surface at a predetermined pitch in the crawler peripheral direction. The lugs (11) extend to a crawler widthwise end (10b) of the crawler outer peripheral surface (10a). A recess (15) recessed inward in the crawler width direction is formed on the outer end surface (12e) of the crawler widthwise outer end of each lug (11), the outer end surface (12e) facing outward in the crawler width direction. The outline of the recess (15) is separated from the outline of the outer end surface (12e) by a predetermined distance. The opening of the recess (15) has a substantially triangular shape.

### TECHNICAL FIELD

The present disclosure relates to a rubber crawler.

### BACKGROUND

A plurality of lugs protrude from the ground contact surface (lug surface) of a rubber crawler that is made of an endless rubber elastic body and mounted on a vehicle used in construction, civil engineering, farming, and the like. The lugs are arranged in various lug patterns in accordance with use.

In such a rubber crawler, particularly in a large-scale rubber crawler, the vehicle on which the rubber crawler is mounted is also large-scale and heavy. The lugs, along with the ears that are the crawler widthwise edges of the rubber crawler, may therefore become entangled at the road surface side of the rubber crawler when the vehicle turns while driving on a road. If the lugs become entangled at the road surface side of the rubber crawler, rubber strain increases near the steel cords and the like embedded inside the rubber crawler, which may lead to cracks in the lugs.

In light of these circumstances, the bending rigidity of the ears of the rubber crawler can be reduced to a certain extent by separating the position where the lugs project from the ground contact surface of the rubber crawler (the position of the base of the lugs) slightly from the ear, i.e. by removing the crawler widthwise outer end of the lug from the crawler widthwise end of the rubber crawler towards the crawler widthwise center. This has been proven analytically to lead to a reduction in rubber strain. Currently, therefore, typical large-scale rubber crawlers sometimes have a shape such that the lugs rise from a position separated by a certain distance from the ear of the rubber crawler towards the crawler widthwise center.

### SUMMARY

### Technical Problem

As described above, however, adopting a shape such that the lugs rise from a position separated by a certain distance from the ear of the rubber crawler prevents the width of the lug in the crawler width direction from being expanded all the way to the crawler widthwise outer end of the rubber crawler, which limits attempts to improve the durability of the rubber crawler.

It is an objective of the present disclosure to provide a rubber crawler that has improved durability while suppressing an increase in rigidity of the crawler widthwise edges, even when the width of the lug in the crawler width direction is expanded to the crawler widthwise outer end of the rubber crawler.

### Solution to Problem

To achieve the aforementioned objective, a rubber crawler according to the present disclosure includes an endless rubber elastic body and protruding lugs formed on an outer peripheral surface at a predetermined pitch in a crawler peripheral direction. The lugs extend to a crawler widthwise end of a crawler outer peripheral surface. A recess recessed inward in a crawler width direction is formed on an end surface of a crawler widthwise outer end of the lugs, the end surface facing outward in the crawler width direction. An outline of the recess is separated from an outline of the end surface by a predetermined distance. An opening of the recess has a substantially triangular shape.

### Advantageous Effect

The present disclosure can provide a rubber crawler that has improved durability while suppressing an increase in rigidity of the crawler widthwise edges, even when the width of the lug in the crawler width direction is expanded to the crawler widthwise outer end of the rubber crawler.

### BRIEF DESCRIPTION OF THE DRAWINGS

In the accompanying drawings:

FIG. 1A is a perspective view illustrating, from the ground contact surface side, a portion cut in the crawler peripheral direction of a rubber crawler according to an embodiment of the present disclosure;

FIG. 1B is a plan view illustrating, from the ground contact surface side, a portion cut in the crawler peripheral direction of a rubber crawler according to an embodiment of the present disclosure;

FIG. 2A is a partial enlarged view illustrating an enlargement of portion X of FIG. 1B; and

FIG. 2B is a cross-section along line A-A of FIG. 2A, illustrating an enlargement of portion X of FIG. 1B.

### DETAILED DESCRIPTION

An embodiment of the present disclosure is described below with reference to the drawings.

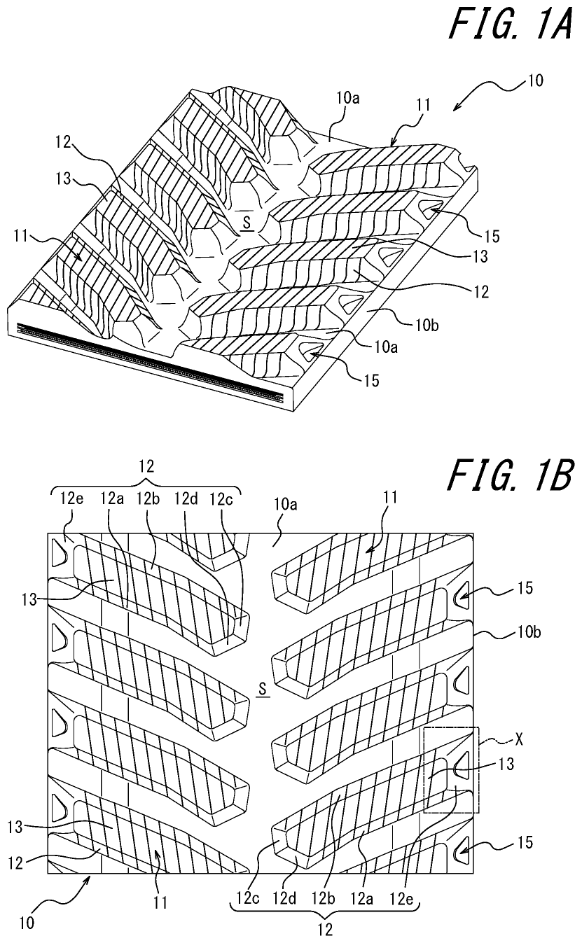

As illustrated in FIGS. 1A and 1B, a rubber crawler 10 according to the present embodiment is configured as an endless, fixed-width rubber elastic body having convex lugs 11 formed at a predetermined pitch in the crawler peripheral direction on the outer peripheral surface (crawler outer peripheral surface). The rubber crawler 10 is mounted on a vehicle used in construction, civil engineering, farming, or the like and is driven by a driving force being transmitted thereto from a driving force generator provided in the vehicle.

In the present embodiment, the lugs 11 protrude from a crawler outer peripheral surface 10a that becomes the crawler running surface. Each lug 11 is convex, with a substantially trapezoidal cross-section in the crawler peripheral direction, and includes a peripheral surface 12, shaped as an inclined vertical wall that becomes narrower towards the top, and a ground contact surface (tread) 13, which is a substantially rectangular flat surface in plan view, at the apex (see FIGS. 1A and 1B). In the present embodiment, the lugs 11 are inclined at a predetermined angle relative to the crawler width direction in plan view and extend in the crawler width direction while bending so that the central portion in the crawler width direction has a greater inclination angle (see FIGS. 1A and 1B).

In the present embodiment, the plurality of the lugs 11 are provided in parallel at a predetermined pitch, in the crawler peripheral direction, across the entire crawler outer peripheral surface 10a in the crawler peripheral direction and are divided into two groups on either side of a groove-shaped space S that extends in the crawler peripheral direction at the crawler widthwise center in plan view. The groups are shifted by substantially half the pitch in the crawler peripheral direction and are substantially symmetrical in the crawler width direction (see FIGS. 1A and 1B).

Consequently, in the present embodiment, the lugs 11 are lined up on the crawler outer peripheral surface 10a at predetermined intervals in the crawler peripheral direction roughly in a v-shape (see FIGS. 1A and 1B) that opens towards the reverse direction, opposite from the forward direction (the downward direction on the page in FIGS. 1A and 1B), of the rubber crawler 10 as mounted on a vehicle. The lugs 11 are not limited to being arranged roughly in the above-described v-shape that opens towards the reverse direction of the rubber crawler 10 and may instead be arranged in the opposite direction, roughly in a v-shape that opens towards the forward direction of the rubber crawler 10.

The rubber crawler 10 in the present embodiment is a large-scale rubber crawler 10 in which the height of the lugs 11 from the crawler outer peripheral surface 10a is 40 mm or more and is a maximum of approximately 70 mm.

The present disclosure is particularly suitable for such large-scale rubber crawlers with lugs that are 40 mm or more, more preferably 50 mm or more.

In the present embodiment, the peripheral surface 12 includes a first side surface 12a and a second side surface 12b that face the crawler peripheral direction and bend in the crawler peripheral direction in correspondence with the shape of the ground contact surface 13, an inner first end surface 12c and inner second end surface 12d that face the crawler width direction, and an outer end surface 12e (see FIGS. 1A and 1B). In the present embodiment, the first side surface 12a is the kick-in surface of the lug 11, and the second side surface 12b is the kick-out surface of the lug 11.

In the present embodiment, the first side surface 12a, the second side surface 12b, the inner first end surface 12c, and the inner second end surface 12d are formed as flat surfaces rising up from the crawler outer peripheral surface 10a via a curved surface protruding inwards (see FIG. 1A). The outer end surface 12e is formed as a flat surface rising up straight from the crawler outer peripheral surface 10a and a crawler widthwise end 10b. The inner first end surfaces 12c positioned on either side of the groove-shaped space S at the crawler widthwise center face each other while being shifted by substantially half the pitch in the crawler peripheral direction (see FIGS. 1A and 1B).

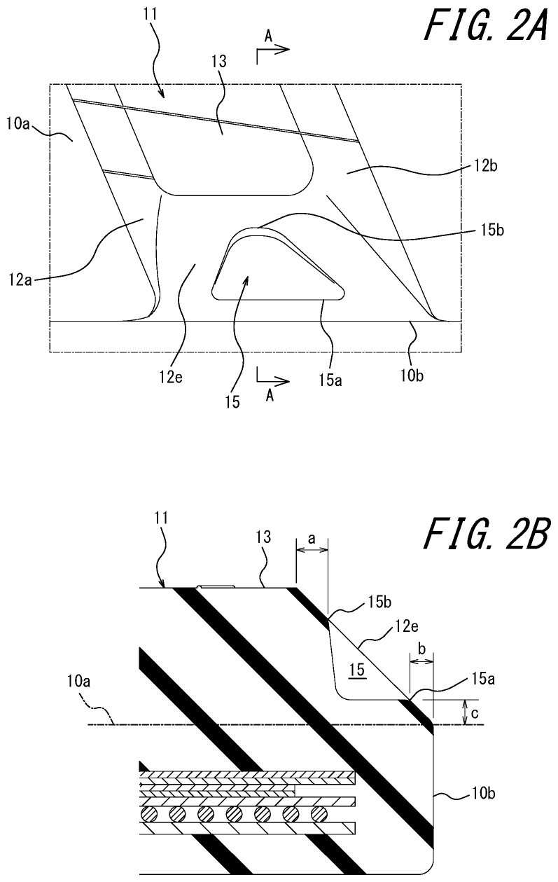

In other words, the outer end surface 12e of the lug 11 in the present embodiment is formed to extend to the crawler widthwise end 10b of the crawler outer peripheral surface 10a so as to reach the crawler widthwise end 10b (see FIGS. 1A, 1B, 2A, and 2B).

The lugs 11 in the present embodiment have an asymmetrical shape with different inclination angles on either side in the crawler peripheral direction. This example is not limiting, however, and the lugs 11 may have any shape and arrangement that achieve the objective of the present disclosure.

The rubber crawler 10 made of a rubber elastic body has, for example, members such as reinforcing cords configured by steel cords embedded therein in the present embodiment. The internal structure and the like of the rubber crawler 10 may, however, be freely chosen.

As illustrated in FIGS. 1A, 1B, 2A, and 2B, a plurality of rows of minute protrusions (vent ridges) 14 are formed in the present embodiment on the side surfaces facing the crawler peripheral direction of the lugs 11, i.e. the first side surface 12a and the second side surface 12b. The minute protrusions 14 extend in a direction intersecting the crawler width direction when viewed from the crawler peripheral direction and are side-by-side in the crawler width direction (see FIGS. 1A, 1B, 2A, and 2B). These minute protrusions 14 formed on the first side surface 12a and the second side surface 12b are also formed in the present embodiment as rows side-by-side in the crawler width direction on the ground contact surface 13 of the lugs 11, continuously with the first side surface 12a and the second side surface 12b (see FIGS. 1A, 1B, 2A, and 2B).

Accordingly, in the present embodiment, a plurality of rows of ridge-shaped minute protrusions 14 extending continuously in the crawler peripheral direction on the first side surface 12a, the ground contact surface 13, and the second side surface 12b, which are the portion of the lug 11 protruding from the crawler outer peripheral surface 10a, are arranged on the lugs 11 at substantially equal intervals in the crawler width direction in plan view (see FIGS. 1A, 1B, 2A, and 2B). The minute protrusions 14 are formed to protrude from each of the first side surface 12a, the ground contact surface 13, and the second side surface 12b, which are surfaces of the lug 11.

The minute protrusions 14 on the first side surface 12a and second side surface 12b need not be formed over the entire range of the peripheral surface 12 in the height direction from the crawler outer peripheral surface 10a, i.e. the lowest portion of the lug 11, to the ground contact surface 13, i.e. the highest portion. It suffices for at least a component to extend in the height direction of the peripheral surface 12 as viewed in the crawler peripheral direction. In the present embodiment, the minute protrusions 14 are also formed on the curved surface, in contact with the crawler outer peripheral surface 10a, that protrudes inwards. Formation of the minute protrusions 14 may be omitted at the curved surface, in contact with the crawler outer peripheral surface 10a, that protrudes inwards. The minute protrusions 14 need not be formed continuously across the first side surface 12a, ground contact surface 13, and second side surface 12b and may be formed instead only on the first side surface 12a, only on the first side surface 12a and the ground contact surface 13, only on the second side surface 12b, or only on the second side surface 12b and the ground contact surface 13.

At the time of vulcanization to form the rubber crawler 10 having the lugs 11 on which the minute protrusions 14 are formed, the minute protrusions 14 can be formed in the present embodiment by recesses provided in the mold in correspondence with the minute protrusions 14. When the minute protrusions 14 are formed by recesses provided in the mold, the recesses are preferably configured to communicate with an exhaust passage that opens to the outside of the mold. This configuration allows the recesses for forming the minute protrusions 14 to function as vents to discharge air from inside the rubber crawler mold to the outside of the mold at the time of vulcanization molding using the rubber crawler mold. Accordingly, to increase this effect of air release, the minute protrusions 14 are preferably also formed on the ground contact surface 13 and more preferably formed to be continuous from the first side surface 12a and/or the second side surface 12b to the ground contact surface 13, as in the present embodiment.

As illustrated in FIGS. 1A, 1B, 2A, and 2B, a recess 15 recessed inward in the crawler width direction is formed on the outer end surface 12e, i.e. the crawler widthwise outer end surface facing outward in the crawler width direction on the lug 11 that extends to a crawler widthwise end 10b. The outline of this recess 15 is separated from the outline of the outer end surface 12e by a predetermined distance, and the opening of the recess 15 is formed to have a substantially triangular shape (see FIG. 2A). In other words, the recess 15 opens within the outer end surface 12e at a predetermined distance away from the outline around the outer shape of the outer end surface 12e.

In the present embodiment, the outer end surface 12e with the recess 15 formed thereon is formed as an inclined surface that is connected to the crawler widthwise end 10b of the rubber crawler 10 and is inclined upward, i.e. towards the ground contact surface (tread) 13, at an angle of 40° to 80°, for example, relative to the crawler outer peripheral surface 10a (see FIG. 2B). Formation of the outer end surface 12e as an inclined surface in this way increases the flexibility of the crawler widthwise outer end portion of the lug 11.

In the present embodiment, the inclined outer end surface 12e is substantially trapezoidal, with an upper base along the ground contact surface (tread) 13, a lower base along the crawler outer peripheral surface 10a, and as viewed from the crawler width direction, one leg by the first side surface 12a, extending substantially perpendicularly to the crawler outer peripheral surface 10a, and another leg by the second side surface 12b, inclined towards the first side surface 12a relative to the crawler outer peripheral surface 10a (see FIG. 2A).

In the present embodiment, the crawler widthwise inner surface of the substantially triangular shape forming the opening of the recess 15 has a curved shape that protrudes inwards in the crawler width direction. Consequently, the recess 15 in the present embodiment has a substantially triangular shape in plan view, i.e. as seen from the ground contact surface (tread) 13, with a bottom 15a at the crawler outer peripheral surface 10a side and a curved apex 15b, having an arc-shaped cross section, that protrudes towards the ground contact surface (tread) 13 at the ground contact surface (tread) 13 side (see FIG. 2A). A concentration of stress at the apex 15b of the recess 15 can be avoided by forming the apex 15b as a curved surface protruding towards the ground contact surface (tread) 13.

In the present embodiment, the opening of the recess 15 has a substantially triangular shape. In conjunction with the asymmetrical shape of the lugs 11, which have different inclination angles on either side in the crawler peripheral direction, the substantially triangular shape of the opening may also be asymmetrical in plan view, with different inclination angles on either side in the crawler peripheral direction.

The length, in the crawler peripheral direction, of the bottom 15a of the substantially triangular recess 15 in the present embodiment is, for example, 0.4 to 0.7 times the contact length, in the crawler peripheral direction, of the lug 11 with the crawler outer peripheral surface 10a, i.e. the bottom length of the lug 11. The length, in the crawler peripheral direction, of the curved portion of the apex 15b is, for example, 0.1 to 0.3 times the length, in the crawler peripheral direction, of the ground contact surface (tread) 13, which is the top surface of the lug 11.

The crawler widthwise cross-sectional shape of the recess 15 of the present embodiment is substantially triangular. In an example of the substantially triangular shape in a crawler widthwise cross-section, the base is a portion of the inclined outer end surface 12e, and the sides are formed by a side along the lug protrusion direction, which is the height direction, and a side along the crawler outer peripheral surface 10a, which is the depth direction (see FIG. 2B).

In the present embodiment, the ratio of the length of the side in the depth direction to the length of the side in the height direction in the recess 15 with a substantially triangular crawler widthwise cross-section is preferably 1 to 0.8-1.2, more preferably 1 to 1. The angle of the apex of the recess 15 with a substantially triangular crawler widthwise cross-section is preferably 80° to 100°, more preferably 90°.

The crawler widthwise cross-sectional shape of the recess 15 is substantially an isosceles triangle, with substantially equal length sides in the height direction and the depth direction. This configuration can achieve a good balance between suppressing an increase in rigidity of the crawler widthwise edge and improving durability.

The crawler widthwise cross-sectional shape of the recess 15 is not limited to being substantially an isosceles triangle, with substantially equal length sides in the height direction and the depth direction. The recess 15 may instead have a substantially triangular shape in which the side in the height direction is longer or shorter than the side in the depth direction.

The outline of the recess 15 that is substantially triangular at the ground contact surface (tread) 13 side is separated from the outline of the outer end surface 12e, which is substantially trapezoidal at the ground contact surface (tread) 13 side as when viewed from the crawler width direction, by a crawler widthwise distance a of 3-6 mm, for example, at the upper end of the recess 15 and a crawler widthwise distance b of 3-6 mm, for example, at the lower end of the recess 15. The outline of the recess 15 is also separated from the crawler outer peripheral surface 10a at the lower end of the recess 15 by a lug protrusion direction distance c of 3-6 mm, for example.

In other words, the recess 15 is disposed upwards (in the lug protrusion direction) from the crawler outer peripheral surface 10a at a lug protrusion direction distance c of 3-6 mm, for example, from the bottom of the lug 11, i.e. the crawler outer peripheral surface 10a (see FIG. 2B).

In this way, the outer end surface 12e, which is the crawler widthwise outer end surface facing outward in the crawler width direction, of the lug 11 is formed as an inclined surface continuous with the crawler widthwise end 10b (see FIG. 2B). The width of the lug 11 in the crawler width direction can thus be expanded all the way to the crawler widthwise end 10b of the rubber crawler 10 without provision of ears, i.e. crawler widthwise edges, in the rubber crawler 10 (see FIGS. 1A, 1B, 2A, and 2B). This improves the durability of the rubber crawler 10.

Furthermore, provision of the recess 15 on the outer end surface 12e of the lug 11 can suppress an increase in rigidity of the crawler widthwise outer end of the lug 11 even if the width of the lug 11 in the crawler width direction is expanded. Additionally, when the recess 15 has the above-described configuration, a concentration of stress at the crawler widthwise outer end of the lug 11 can be prevented, ensuring durability at the crawler widthwise outer end of the lug 11.

In a large-scale rubber crawler in which the lugs 11 have a height of 40 mm or more, in particular 50 mm or more, from the crawler outer peripheral surface 10a, the lugs become entangled at the road surface side of the rubber crawler when the vehicle turns while driving on a road, and rubber strain increases near the steel cords embedded inside the rubber crawler, leading to cracks in the lugs. As a result of the above-described configuration, such cracking can be suppressed insofar as possible, which also reduces the occurrence of defects in appearance.

### REFERENCE SIGNS LIST

10 Rubber crawler
10a Crawler outer peripheral surface
10b Crawler widthwise end
11 Lug
12 Peripheral surface
12a First side surface
12b Second side surface
12c Inner first end surface
12d Inner second end surface
12e Outer end surface
13 Ground contact surface
14 Minute protrusion
15 Recess
15a Bottom
15b Apex

1. A rubber crawler comprising an endless rubber elastic body and protruding lugs formed on an outer peripheral surface at a predetermined pitch in a crawler peripheral direction;
wherein the lugs extend to a crawler widthwise end of a crawler outer peripheral surface;
wherein a recess recessed inward in a crawler width direction is formed on an end surface of a crawler widthwise outer end of the lugs, the end surface facing outward in the crawler width direction;
wherein an outline of the recess is separated from an outline of the end surface by a predetermined distance; and
wherein an opening of the recess has a substantially triangular shape.

2. The rubber crawler of claim 1, wherein a crawler widthwise inner surface of the substantially triangular shape of the recess has a curved shape.

3. The rubber crawler of claim 1 or 2, wherein a crawler widthwise cross-sectional shape of the recess is substantially an isosceles triangle.

4. The rubber crawler of claim 3, wherein a ratio of a length of a side in a depth direction to a length of a side in a height direction in the recess, which has the substantially triangular shape as the crawler widthwise cross-sectional shape, is 1 to 0.8-1.2.

5. The rubber crawler of claim 1, wherein a height of the lugs from the crawler outer peripheral surface is 40 mm or more.

6. The rubber crawler of claim 2, wherein a crawler widthwise cross-sectional shape of the recess is substantially an isosceles triangle.

7. The rubber crawler of claim 6, wherein a ratio of a length of a side in a depth direction to a length of a side in a height direction in the recess, which has the substantially triangular shape as the crawler widthwise cross-sectional shape, is 1 to 0.8-1.2.

8. The rubber crawler of claim 2, wherein a height of the lugs from the crawler outer peripheral surface is 40 mm or more.

9. The rubber crawler of claim 3, wherein a height of the lugs from the crawler outer peripheral surface is 40 mm or more.

10. The rubber crawler of claim 6, wherein a height of the lugs from the crawler outer peripheral surface is 40 mm or more.

11. The rubber crawler of claim 4, wherein a height of the lugs from the crawler outer peripheral surface is 40 mm or more.

12. The rubber crawler of claim 7, wherein a height of the lugs from the crawler outer peripheral surface is 40 mm or more.
